(19) United States
(12) Patent Application Publication
(10) Pub. No.: US 2002/0112618 A1
(43) Pub. Date: Aug. 22, 2002

(54) Printing method and apparatus

(76) Inventors: Thomas William Bailey, Coventry (GB); David Christopher Miller Carter, Coventry (GB); Michael Edkins, Coventry (GB); Graham Leonard Shirley, Coventry (GB)

Correspondence Address: JENSEN & PUNTIGAM, P.S., 1020 United Airlines Bldg., 2033 Sixth Avenue, Seattle, WA, 98121-2584, US

(21) Appl. No.: 09/815,135

(22) Filed: Mar. 22, 2001

Related U.S. Application Data
(63) Continuation of application No. PCT/GB99/03118, filed on Sep. 20, 1999.

(30) Foreign Application Priority Data
Sep. 22, 1998 (GB) 9820629.5
May 4, 1999 (GB) 9910288.1

(51) Int. Cl. B41F 1/00

(52) U.S. Cl. 101/2

(57) ABSTRACT

Apparatus for applying foil to a stock, including means for moving the stock and foil and foil supporting carrier to a printing position where pressure is applied to transfer a predetermined shape of foil which is adhered to the stock and wherein the means for moving includes a first means for moving the carrier at the speed of the stock during the printing operation and second means for moving the carrier at a slower speed between printing operation and the method of using the apparatus.

This application is a continuation of PCT/GB99/03118.

This invention relates to printing apparatus, and in particular to such apparatus for carrying out a process commonly known as hot foil stamping.

In security printing apparatus it is known to apply a thin layer of metal foil of predetermined shape and/or pattern to a stock, eg a sheet of bank notes, usually as a feature intended to make counterfeiting more difficult. For this purpose the foil may carry a hologram or other security image. In a typical application the foil is carried as a continuous lamination between a carrier substrate and a layer of hot melt adhesive, the shape or pattern to be applied being determined by a stamp or press. In prior art arrangements the carrier substrate and the stock (eg a sheet of bank notes) are placed together beneath a platen-type press carrying an array of stamps which are simultaneously applied to cause an array of hot foil imprints to be applied to the stock. Heat for activating the hot melt adhesive is generally applied from the press, and an inability to transfer heat sufficiently quickly is a factor inhibiting the speed of such prior art arrangements.

In EP 441 596A, the disclosure of which is hereby incorporated herein in its entirety, a web carrying foil images is moved together with a stock through a rotary press to apply the images to the stock. The web is moved at the same speed as the stock during image application but at a lower speed between application steps, so as to allow relatively close spacing of the images on the web. The web is retracted following each application to compensate for the distance travelled during acceleration and deceleration during each cycle. In the rotary press the images are pressed onto adhesive patches provided on the stock at predetermined positions.

WO 96/37368 provides an improved method and apparatus for applying foil to a stock by means of a hot melt adhesive, in which adhesive carried with the foil is pre-heated by means which applies heat directly to the adhesive layer. An alternative drive arrangement is also disclosed. The disclosure of WO 96/37368 is hereby incorporated herein in its entirety.

According to one aspect of the invention apparatus for applying foil to a stock comprises means for conveying a carrier for the foil towards a printing position, means for conveying a stock towards the printing position, printing means at which the carrier and stock are moved together past said printing position at which pressure is applied to transfer a predetermined pattern and/or shape of foil from the carrier to the stock and so that the predetermined pattern and/or shape of foil is adhesively secured to the stock, wherein the means for conveying the carrier includes first means for conveying the carrier at the speed of the stock at least during each printing operation, and second means for moving the carrier at a lower speed between printing operations, the first means including operating means which is capable of imposing no substantial resistance to movement of the carrier by the second means at least for a substantial proportion of the period during which the carrier is moved at a lower speed. Preferably said drive means includes means which is out of contact with said carrier during said periods. The first means may comprise means such as stamps or dies carried by the printing means and/or conveyor means downstream of the print position. In a preferred arrangement said conveyor means comprises opposed rollers, which may be segmented, which contact the carrier for a period corresponding to the period while printing is taking place and for a short period afterwards while the adhesive between the foil and the stock is setting. The relative timing of the opposed rollers may be adjusted by adjusting the relative phases of the portions of the rollers (eg segments) which contact the carrier.

By imposing no or substantially no resistance to reversal or movement of the carrier at other lower speeds, the drive means facilitates such movement and hence allows higher speed operation and/or operation with low ratios between the pitch between application positions and the length of each foil patch. By contrast, in the machine according to EP 441596A the capstan rolls 58, 60 remain in contact with the carrier during reversal of the tape and may be unable to achieve the necessary high frequency reversal of operation in such circumstances. In the present arrangement reversal of the carrier, where required, may be achieved substantially entirely by pneumatic means, eg by reversal into a pneumatic reservoir, avoiding the need for high frequency operation of reciprocating drive means.

According to another aspect of the invention apparatus for applying foil to a stock comprises means for conveying a carrier for the foil towards a printing position, means for conveying a stock towards the printing position, printing means at which the carrier and stock are moved together past said printing position at which pressure is applied to transfer a predetermined pattern and/or shape of foil from the carrier to the stock and so that the predetermined pattern and/or shape of foil is adhesively secured to the stock, wherein the means for conveying the carrier includes first means for conveying the carrier at the speed of the stock at least during each printing operation, and second means for moving the carrier at a lower speed and preferably reversing it between printing operations, the first means including periodically-operating means for displacing the carrier downstream of the printing position. The displacing means may comprise a roller which is movable to deflect the carrier and during such movement to modulate the speed of the carrier so that it matches the speed of the stock during the printing operation. Hence the displacing means may cause a speed modulation of the carrier by displacing it, eg extending the path of the carrier between the printing position and drive or other carrier engaging means downstream of the displacing means. In a preferred arrangement a roller of the displacing means is movable across the path of the carrier (or is movable to extend the path of the carrier) by means (eg a cam) synchronised with the printing means. Between printing operations the carrier may be driven at substantially constant speed by drive means arranged downstream of the displacing means.

The second means may include drive means for the carrier downstream of said first means, said drive means being arranged to move the carrier at a nominal speed preferably corresponding to its average speed during and between each printing operation. The second means may further include pneumatic means (eg a pneumatic reservoir) upstream of the print position.

According to a further aspect of the invention apparatus for applying foil to a stock comprises means for conveying a carrier for the foil towards a printing position, means for conveying a stock towards the printing position, printing means at which the carrier and stock are moved together past said printing position at which pressure is applied to transfer a predetermined pattern and/or shape of foil from the carrier to the stock and so that the predetermined pattern and/or shape of foil is adhesively secured to the stock, wherein the means for conveying the carrier includes first means for conveying the carrier at the speed of the stock at least during each printing operation, and second means for moving the carrier at a lower speed and preferably reversing it between printing operations, the second means including drive means arranged downstream of said printing position for conveying the carrier at a nominal speed which is preferably the average of the speed of the carrier during and between said printing operations. The drive means may be arranged to move the carrier at constant speed but preferably moves it at a controlled speed which may be adjusted, for example in response to signals derived from the stock downstream of the printing position, so as to maintain synchronisation of the carrier and stock. It will be understood that such adjustments may normally be relatively small.

In a preferred arrangement the drive means includes a drive roll having a compliant portion whereby its peripheral speed may be adjusted independently of its rotational speed. Thus a drive roll provided for example with a resilient peripheral surface and cooperating with a counter roll to drive the carrier may be subject to an adjustable or variable load so as to compress the surface by an adjustable or variable amount and hence adjust or vary the peripheral driving speed of the roll for a given rotational speed. In such an arrangement the load applied may be adjusted by a solenoid or other simple electromagnetic means which effectively provides alternative load settings, or by a more sophisticated load applying device, eg including a linear actuator. Where the load applying device has only two settings, these may be conveniently arranged so that the peripheral speed of the roll at one setting is slightly below and at the other setting is slightly above the nominal speed. In this way, by controlling the load applied in response to signals dependent on synchronisation of the carrier and the stock, the average speed of the carrier may be accurately controlled by relatively frequent switching between the load settings.

According to a further aspect of the invention a method of applying foil to a stock includes conveying a carrier for the foil towards a printing position, conveying a stock towards the printing position, moving the carrier and stock together past said printing position so as to transfer successive predetermined patterns and/or shapes of foil from the carrier to the stock and so that the predetermined pattern and/or shape of foil is adhesively secured to the stock, conveying the carrier at a desired speed at least during each printing operation and at a lower speed between printing operations, conveying the carrier at a position downstream of the printing position at a nominal speed which preferably corresponds to the average speed of the carrier during and between printing operations, and modulating the speed of the carrier between the printing position and said downstream position so as to achieve the desired speed of the carrier during each printing operation. The desired speed preferably corresponds to the speed of the stock.

According to a further aspect of the invention apparatus for applying foil to a stock comprises means for conveying a carrier for the foil together with an adhesive which is activated by heat towards a printing position, means for conveying a stock towards said printing position, printing means at which the carrier and stock are moved together past said printing position at which pressure is applied to transfer a predetermined pattern and/or shape of foil from the carrier to the stock, including means for applying heat to activate the adhesive at or upstream of the printing position, and cooling means downstream of said printing position for assisting setting of said adhesive, whereby the foil is adhesively secured to the stock and the carrier may be separated from the foil adjacent said printing position. The cooling means may comprise means for directing cooling air at the printing position or at the carrier just downstream of the printing position; for example, cooling air may be directed at or adjacent the downstream nip between a print wheel and a counterwheel at said print position or at the counterwheel just downstream of the nip, ie where the carrier is separated from the foil.

In a preferred arrangement means are provided downstream of the print position for separating the carrier and the stock; the separating means may comprise a stripper bar or plate, also located closely adjacent the downstream nip between a print wheel and a counterwheel at the print position.

Cooling the adhesive allows faster setting thereby also allowing separation of the carrier from the stock closer to the print position. In machines where the carrier is reversed between printing operations this allows reversal to start earlier and hence provides additional time for reversal, thereby potentially allowing faster operation of the machine.

According to a further aspect of the invention apparatus for applying foil to a stock comprises means for conveying a carrier for the foil towards a printing position, the foil carrying on an outer side an adhesive which is activated by heat, means for conveying a stock towards said printing position, printing means at which the carrier and stock are moved together past said printing position at which pressure is applied to transfer a predetermined pattern and/or shape of foil from the carrier to the stock and so that adhesive secures the predetermined pattern and/or shape of foil to the stock, and preheating means for transferring heat to the carrier before it reaches the printing position and/or before it contacts the stock, wherein the preheating means comprises means extending longitudinally of the path for the carrier substantially up to the printing position. Preferably the preheating means comprises guide means for the carrier. Preferably the guide means is heated, eg electrically or by heated air. The preheating may be achieved substantially entirely by use of heated air, ie without additional heating for the guide means. In one preferred arrangement the guide means includes means defining a channel for the carrier and means is provided for supplying heated air to the channel. The supplying means may include an air mover. The air supplied to the channel may assist in conveyance of the carrier through the channel. The guide means may be formed with a slight curvature to maintain the carrier in contact with a surface, which may itself be heated.

In another preferred arrangement the preheating means comprises means carried by the printing means. Thus the printing means may comprise rotary means and the preheating means may comprise means for guiding the carrier into contact with the printing means upstream of the printing position, whereby heat may be transferred to the carrier while it is being conveyed to said position. The printing means may comprise spaced first regions (eg stamps) for transferring the predetermined pattern and/or shape of foil to the stock at said printing position, which first regions may be heated, and second regions intermediate said first regions; preferably said second regions are provided with heat, eg by heating elements which are separate from any heating elements for said first regions.

Where the preheating means comprises means contacting the carrier on its side opposite its adhesive layer, preferably it comprises additionally means for directing heat at the adhesive layer, which means may comprise any of such means disclosed in WO 96/37368.

Apparatus in accordance with any of the aspects of the present invention may be incorporated in printing machinery for applying foil patches at spaced positions on a stock, eg machinery of the kind disclosed in EP 441596A. In such machinery the carrier is reversed between printing operations, and at high operating speeds and/or where the length of the patch to be applied is long relative to the pitch between application positions, the time available for reversal of the carrier is short. In such cases, providing a relatively uncomplicated path for that portion of the carrier which is to be reversed can be important. Arranging for preheating to be achieved by longitudinally-extending means can be advantageous in this respect, as compared with preheating by use of a separate preheating bar, as disclosed in WO 96/37368, which can result in a convoluted path for the carrier.

The various aspects of the invention may be incorporated in any combination in common apparatus, which may incorporate also any aspects of the arrangements disclosed in WO 96/37368.

The term “foil” is used herein for convenience: the apparatus may be used for printing any image transferable from a carrier onto a stock and the term should be construed accordingly.

The invention will be further described, by way of example only, with reference to the accompanying diagrammatic drawings, in which

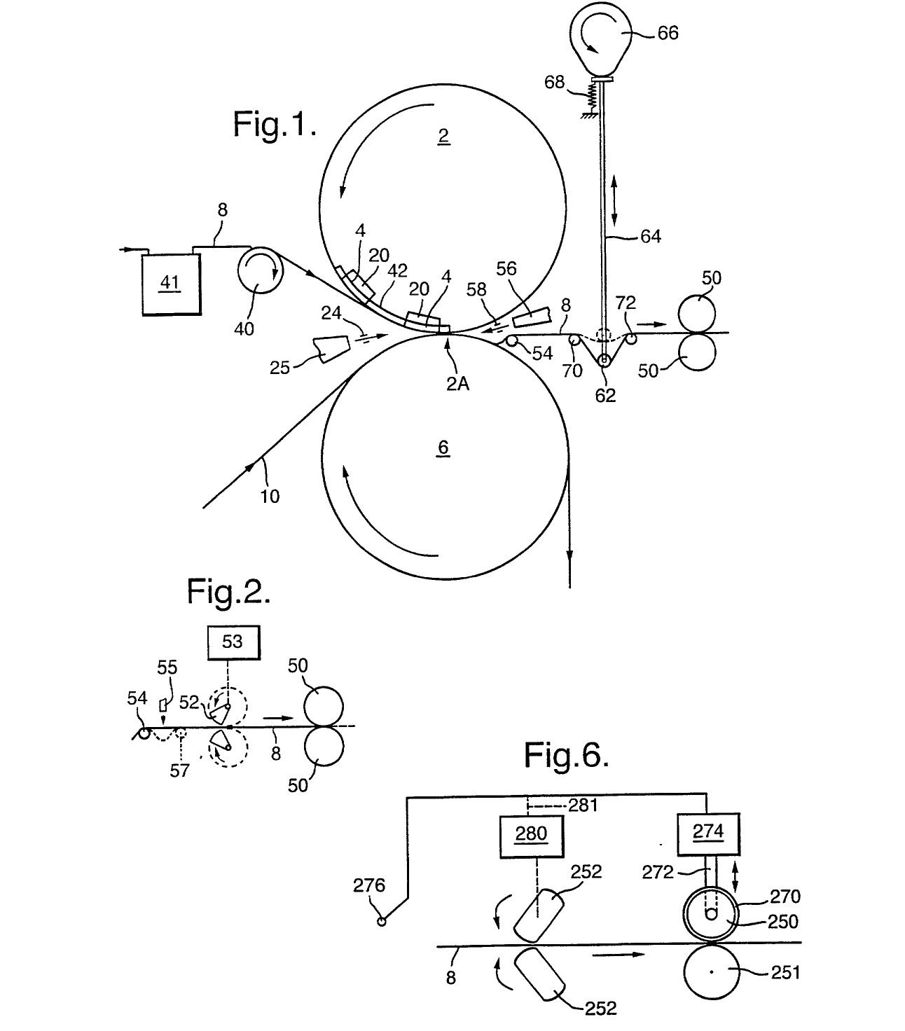

FIG. 1 is a side view of part of a foil printing apparatus,

FIG. 2 is a side view of part of a modification of the apparatus of FIG. 1,

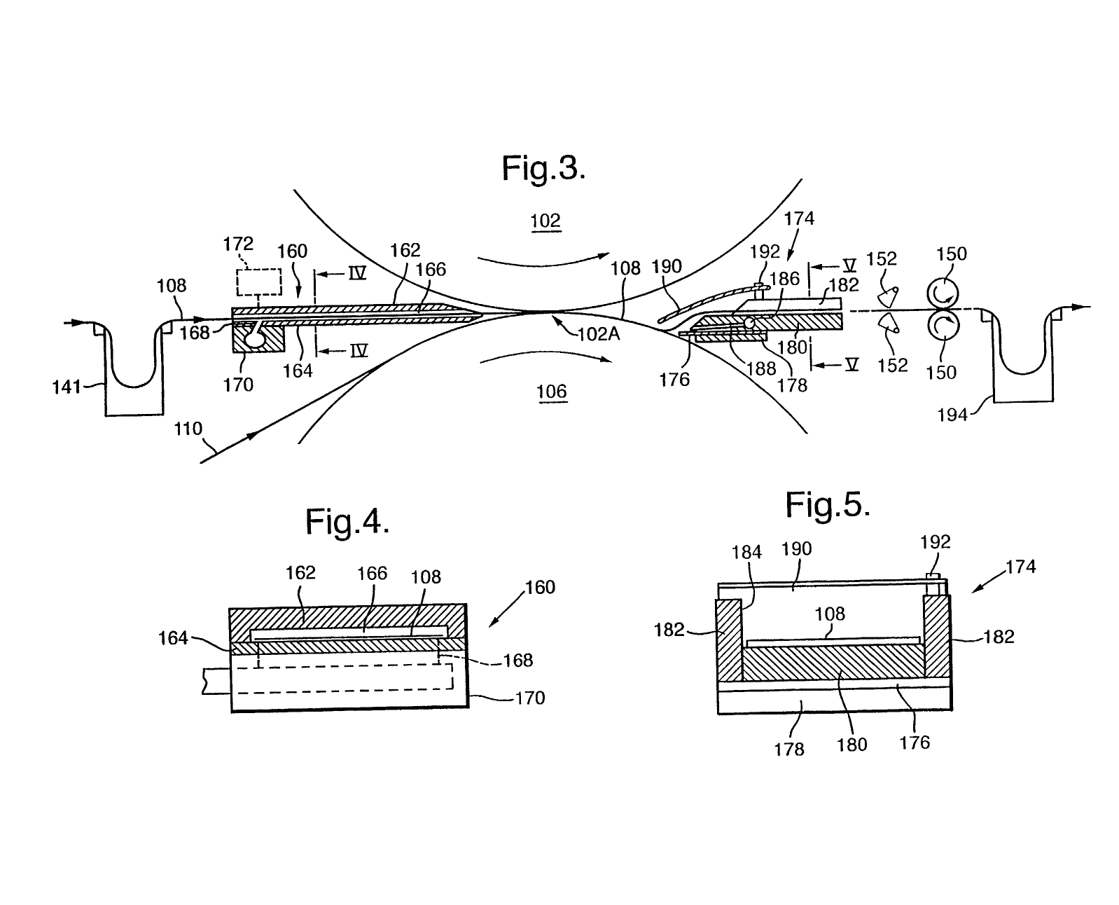

FIG. 3 is a side view partly in section of another foil printing apparatus,

FIG. 4 is a sectional view on the line IV-IV in FIG. 3,

FIG. 5 is a sectional view on the line V-V in FIG. 3, and

FIG. 6 is a side view of part of another modified foil printing apparatus.

The apparatus shown in FIG. 1 comprises a driven printing wheel 2 carrying a series of heated dies or stamps 4 (only two of which are shown in the drawing) which cooperate with a driven substrate wheel 6. A tape 8 carrying foil to be printed is delivered to the nip 2A of the wheels 2 and 6 along with a web or sheet 10 on which a foil pattern corresponding to that on the stamp 4 is to be printed. The web or sheet 10 could be packaging material, eg a blank for a packet. In an alternative arrangement (not shown) the wheel 2 could be arranged to apply foil directly to an article other than a web or sheet, eg a packet, in appropriate cases.

The apparatus shown has similarities with that disclosed in WO 96/37368 and may be used for any of the purposes disclosed therein. In particular, the apparatus may form part of a security printing machine such as that disclosed in EP 441596A. Thus, the wheels 2 and 6 may correspond to the cylinders 46 and 48 in that machine. The tape 8 is driven in a manner which is similar to the way in which the tape 34 is driven in EP 441596A, that is to say for each printing cycle it is accelerated up to the speed of the web 10 (normally corresponding to the peripheral speed of the wheels 2 and 6), maintained at that speed while the stamp 4 passes through the nip 2A between the wheels 2 and 6, and subsequently decelerated to rest and reversed so that the net advance of the tape for each printing cycle corresponds to or only slightly exceeds the length of the image to be imprinted by the stamp 4.

The tape 8 comprises a polyester carrier layer, a layer of release wax, a foil layer and a layer of hot melt adhesive. Travel of the tape 8 and web 10 through the nip 2A between wheels 2 and 6 causes a pattern of foil corresponding to that determined by raised areas of the stamp 4 to be released from the carrier layer and to be adhesively secured to the web 10 by means of the hot melt adhesive layer activated by the heated stamp 4. Reference may be made to WO 96/37368 for further details.

As in WO 96/37368, hot air is directed at the adhesive layer of the tape 8 just upstream of the nip 2A between the wheels 2 and 6, as indicated at 24, by a blower unit 25. Any of the additional or alternative heating means referred to in WO 96/37368 may be used.

The tape 8 is constrained, by a roller 40 upstream of the wheels 2 and 6, so that it wraps partly around the wheel 2 upstream of the nip 2A between the wheels 2 and 6. Upstream of the roller 40 is a pneumatic tape reservoir 41, from where tape 8 is withdrawn and which imposes tension on the tape such that any slack in the tape downstream of the reservoir is taken up. The stamps 4 are provided with cartridge heaters 20 for applying heat at the nip 2A, and contact of the tape 8 with them upstream of the nip is effective in transferring heat to the tape. The regions of the wheel 2 between the stamps 4 may also be heated, eg by additional heating elements 42, so as to provide additional heat to the tape 8 upstream of the nip 2A. In this way adequate heat may be supplied to the tape 8 to allow high speed operation without requiring a convoluted path for the tape which might impede tape reversal.

At high operating speeds and where the ratio of the pitch between application positions on the web 10 and the length of the foil to be transferred is low, the time available for reversal of the tape 8 is short. In the arrangement of EP 441596 reversal of the tape is controlled by capstan drive rolls downstream of the transfer position, the suction reservoir merely operating to take up slack in the tape. At such high operating speeds and/or at such low pitch/length ratios, the required frequency of reciprocation of the capstan rollers may be difficult and/or expensive to achieve reliably. In the present apparatus capstan drive rolls 50 for the tape 8 are provided downstream of the wheels 2, 6 and are driven at a constant speed corresponding to advancing the tape by one pitch of the image on the tape for every pitch between image positions on the web 10. The speed of the tape 8 is modulated, so that it is running at the speed of the web 10 during transfer of foil imprints to the web, by means of a roller 62, arranged in the path of the tape between the wheels 2, 6 and the capstan rolls 50, and which is carried by a sliding rod 64 longitudinally movable under action of a rotatable cam 66 and return spring 68. The path of the tape 8 around the roller 62 is defined by stationary rollers 70, 72. The rotation of the cam 66 is synchronised with that of the wheels 2, 6 so that movement of the roller under action of the cam to modulate the path length of the tape 8 between the rollers 70 and 72 correspondingly modulates the velocity of the tape so that it is running at the speed of the web 10 during transfer. Note that the tape 8 is also driven at the speed of the web 10 during transfer as a result of nip pressure between the regions of the wheel 2 containing the stamps 4 and the wheel 6 but for accuracy and reliability especially at higher speeds additional downstream speed control means such as the roller 62 is required.

The action of the roller 62 operates to modulate the speed of the tape 8 only during periods when it is required to move it at the speed of the web 10: this is during application of the foil image to the web and for a period corresponding to a short distance immediately following the nip 2A between the wheels 2 and 6 during which the adhesive between the foil image and the web is setting and during which the tape 8 follows the path of the web 10 around the wheel 6 for a short distance (eg 30 mm). At times other than when it is required to move the tape 8 at the speed of the web 10, the action of the roller 62 is relatively neutral, so that it does not impede reversal of the tape 8 by the pneumatic reservoir 41 located upstream of the roller 40. Pressure at the nip 2A (if any) is much lower during periods when a stamp 4 is not passing through, so that the tape 8 may be decelerated and reversed by action of the reservoir 41.

In order to control the position at which the tape 8 and web 10 separate downstream of the nip 2A between the wheels 2 and 6 a small diameter stripper bar 54 is located close to the nip.

It will be appreciated that by reducing the setting time of the adhesive it is possible to reduce the total time during which the tape 8 must be moved at the speed of the web 10 and hence provide more time for reversal of the tape. A blower 56 directs cooling air at the downstream nip between wheels 2 and 6, as indicated at 58. Cooling the adhesive allows the distance during which the tape 8 must be allowed to remain with the web 10 to be reduced, hence also allowing the stripper bar 54 to be moved closer to the nip.

FIG. 2 shows part of a modified apparatus in which the roller 62 and its associated drive are replaced by a pair of rotary drive segments 52. The FIG. 2 arrangement also does not require the rollers 70 and 72 of FIG. 1. The rotary segments 52 contact the tape 8 only during periods when it is required to move it at the speed of the web 10. The relative rotational positions of the segments 52 may be altered to adjust timing of their contact with the tape 8, eg by adjustment of the phase of a drive 53 synchronised with that of the wheels 26. As the segments 52 do not contact the tape 8 at times other than when it is required to be moved at the speed of the web 10, they do not impede reversal of the tape 8 by the pneumatic reservoir 41 located upstream of the roller 40. Thus, they have similar advantages to the arrangement of roller 62 in FIG. 1.

As compared with the drive segments 52, the arrangement of roller 62 has the additional advantage of avoiding any snatching of the tape 8 which could occur as the segments contact and release the tape. An air jet device 55 could be provided for taking up and/or controlling the position of any loop in the tape 8 temporarily formed immediately upstream of the segments 52, in which case an additional roller 57 could be provided as indicated in FIG. 2.

The apparatus shown in FIGS. 3-5 is intended to be used in the same way as the apparatus of FIG. 2 and has many similarities with it. Similar parts have been given reference numbers increased by 100 and have similar construction and/or function to corresponding parts in the apparatus of FIG. 2 except where indicated hereinafter.

Upstream of the wheels 102 and 106 the tape 108 passes through a web guide 160 comprising an upper plate 162 provided with a longitudinal recess forming with a lower plate 164 a channel 166 through the guide. At its upstream end the plate 164 has a transverse inclined slit forming an air outlet 168 connected to an air mover device 170. Construction and operation of the device 170 may be substantially similar to that disclosed in GB 2201665A or GB 2226538A, to which reference is directed for details. Air issuing from the outlet 168 flows along the surface of the plate 164 within the channel 166 and assists conveyance of the tape 108, which is particularly useful during initial threading of the tape 108 through the guide 160.

The air supplied to the device 170 is heated (eg to a temperature in the range 100-115° C.) and raises the temperature of the plates 162, 164 to its temperature, at least at their surfaces within the channel 166. The plates 162, 164 thus heated and the hot air delivered by the device 170 serve to preheat the tape 108 for the purposes hereinbefore mentioned. Although heat provided by the device 170 is effective at preheating the tape 108, additional heating means, eg electrical means, may be provided for the upper plate, as indicated at 172. Preferably the tape is preheated to a temperature approaching but somewhat lower than that of the anvils 120.

The upper plate 166 (or the base of the recess in the plate forming the channel 166) is provided with a slightly convex shape longitudinally, i.e. it has a slight curvature similar to that of the wheel 102 as viewed in FIG. 3, so that the tape 108 tends to maintain contact with the plate 162 at the base of the channel 166 during passage through the guide 160. The curvature is small and is not apparent in FIG. 3; typically the device 160 may be approximately 180 mm long and the curvature such that the plate deviates from straight by of the order of 1 mm.

As shown in FIG. 3, the guide 160 extends very close to the nip 102A, so that the preheating effect is maintained up to the nip.

Downstream of the nip 102A the tape 108 is received in a second web guide 174. At its leading end the guide 174 includes a stripper plate 176 which is arranged closely adjacent to the surface of the wheel 106 a short distance from the nip 102A and performs a similar function to the stripper bar 54 (FIG. 1). The plate 176 is clamped by a block 178 to the undersurface of a guide plate 180 over which the tape 108 passes between upstanding side members 182 attached to the sides of the guide plate so as to form a longitudinal recess 184.

The guide plate 180 is formed with a transverse bore 186 connected to an air pressure source, and extending from the bore in a longitudinal direction relative to the plate is a further bore 188 leading to an outlet at the leading end of the plate closest to the nip 102A. Cooling air issuing from the bore 188 is directed along the stripper plate 176 at the tape 108 as it leaves the wheel 106. A cowl 190, formed from a thin strip of metal, is attached to a post 192 connected to one of the side members 182 and extends over the ends of the stripper plate 176 and guide plate 180. The cowl 190 may serve to delimit the extent of movement of the path of the tape 108 away from the stripper plate 176 and guide plate 180 and also constrain any cooling air flowing around the sides of the tape. Cooling air could be additionally directed at the upper surface of the tape 108 by a device similar to the blower 56 of FIG. 1. Air used for cooling may but need not be subject to precooling: forced passage of ambient air will be effective at cooling the adhesive.

Downstream of the web guide 174 the tape 108 is subject to drive by capstan rolls 150, which drive the tape at a substantially constant speed (corresponding to the average speed required for advancement of the tape by one pitch for each required application), and is subject to speed modulation by drive segments 152. As in the FIG. 2 arrangement, during periods when the segments 152 do not contact the tape 108 it is subject to a reversing force imposed by the upstream pneumatic reservoir 141. Downstream of the rolls 151 the tape 108 is passed through a pneumatic web reservoir 194, which controls tension in the web downstream of the rolls. The drive segments 152 could be replaced by an arrangement including a driven roller similar to the roller 62 in FIG. 1. Alternatively, the rolls 150 could be replaced by a reciprocating drive (eg similar to the drive of the capstan rolls 58, 60 in EP 441 596A).

In FIG. 6 part of a modified foil printing apparatus is shown, downstream of the wheels 2, 6 (FIG. 1), where a tape 8 is driven by capstan drive rolls 250, 251, the roll 250 having an outer sleeve 270 of resilient material. The sleeve 270 may for example comprise a cylindrical blanket or a series of laterally-spaced circumferential O-rings, eg made from butyl rubber. The roll 251 and the core of the roll 250 may be made from a rigid material such as steel. Upstream of the rolls 250, 251 is a pair of rotary drive members 252, each of which has opposed circular surfaces which contact the tape 8 only during periods when it is required to move it at the speed of the web 10. Apart from the fact that each of the members 252 has two regions which contact the tape 8, their operation is similar to that of the segments 52 in the FIG. 2 arrangement. In particular, the relative rotational positions of the members 252 may be adjusted to control precisely when the tape 8 is contacted. This may be achieved by mechanical means (eg physically adjusting the rotational position of one of the members 252 relative to the other) or, where the drive to the members includes electronic control means 280, as indicated in FIG. 2, by appropriate adjustment of the phase control signals of one or both members.

The rolls 250, 251 are driven at a rotational speed which corresponds with a nominal peripheral speed corresponding to advancing the tape 8 by one pitch of the image on the tape for every pitch between image positions on the web 10. The roll 250 is the driven roll whereas roll 251 is driven by contact with the roll 250 (or tape 8). It will be appreciated therefore that for a given rotational speed of the roll 250 the peripheral speed of the roll, and hence the linear speed of the tape 8, depends on the radius of the roll 250. Since the roll 250 has a compliant outer layer 270 it is possible to make adjustments to this radius by varying the loading of the roll 250 against the counter roll 251. For this purpose the roll 250 is mounted on a support bar 272 to which an adjustable load is imposed by a controllable device 274. The device 274 could be a simple electromagnetic device such as a solenoid arranged so that the load applied to the roll 250 is at a first or second value dependent on whether the solenoid is or is not activated. In a preferred arrangement, when a first value load is applied the diameter of the roll 250 is such that the peripheral speed of the roll is slightly greater than the nominal speed and when a second value load is applied the diameter is such that the peripheral speed is slightly less than the nominal speed. In conjunction with a sensor 276, which detects the position at which images are being applied to the web 10, eg by reference to registration marks or print on the web 10, the device 274 is operated (on and off) relatively frequently so that the drive imposed on the tape 8 by the rolls 250, 251 alternates between slight underfeeding and slight overfeeding and so that the mean speed is the nominal speed. Note that signals from the sensor 276 may also be used to vary the phasing of the members 252 (as indicated by the signal line 281 in FIG. 2).

Alternatively, the device 274 could comprise a linear actuator operated by a stepper motor so that continuous progressive control could be achieved, theoretically setting the peripheral speed of the rolls 250, 251 at a precise desired speed, eg by measurement of the speed of the tape and appropriate adjustment of the load to achieve the corresponding diameter of roll 250. Of course, the actual rotational speed of the roll 250 can also be altered, or could be varied during operation, although this would probably not be necessary in normal circumstances.

The apparatus of FIG. 6 may be used in the FIG. 1 embodiment (to replace the rolls 50 and rollers 62, 70, and 72), or in the FIG. 2 modification (to replace the rolls 50 and segments 52), the FIG. 3 apparatus (to replace the rolls 150 and segments 152), or in any other disclosed modifications of any of these embodiments. Furthermore the rolls 250, 251 and associated elements could replace the rolls 50 or 150 or any corresponding capstan rolls in any of the illustrated embodiments or in any of the disclosed modifications of any of these embodiments.

Although described by reference to apparatus in which foil images are applied to a stock by means of a hot melt adhesive, the present drive arrangements are equally applicable to apparatus in which images are applied by means of a cold-setting adhesive, eg as in the illustrated embodiment of said EP 441596A.

43. Apparatus for applying foil to a stock, comprising:
means for conveying a carrier for the foil towards a printing position;
means for conveying a stock towards the printing position; and
printing means at which the carrier and stock are moved together past said printing position at which pressure is applied to transfer a predetermined pattern and/or shape of foil from the carrier to the stock, and so that the predetermined pattern and/or shape of foil is adhesively secured to the stock, wherein the means for conveying the carrier includes first means for conveying the carrier at the speed of the stock at least during each printing operation, and second means for moving the carrier at a lower speed between printing operations, the first means including operating means which is capable of imposing no substantial resistance to movement of the carrier by the second means at least for a substantial proportion of the period during which the carrier is moved at a lower speed.

44. Apparatus as claimed in claim 43, wherein the operating means include means which is out of contact with said carrier during said proportion of said period.

45. Apparatus as claimed in claim 43, wherein the first means includes means carried by the printing means.

46. Apparatus as claimed in claim 43, wherein the operating means includes conveyor means arranged downstream of the printing position.

47. Apparatus as claimed in claim 46, wherein the conveyor means comprises opposed members arranged to contact the carrier at least while printing is taking place.

48. Apparatus as claimed in claim 47, wherein said opposed conveyors are arranged to contact the carrier also for a short period after printing, while the adhesive between the foil and the stock is setting.

49. Apparatus as claimed in claim 47, wherein the opposed conveyors comprise segmented rollers.

50. Apparatus as claimed in claim 47, including means for adjusting the relative timing of the opposed conveyors by adjusting the relative phases of portions of the conveyor which contact the carrier.

51. Apparatus as claimed in claim 43, wherein the first means includes periodically-operating means for displacing the carrier downstream of the printing position.

52. Apparatus for applying foil to a stock, comprising:
means for conveying a carrier for the foil towards a printing position;
means for conveying a stock towards the printing position; and
printing means at which the carrier and stock are moved together past said printing position at which pressure is applied to transfer a predetermined pattern and/or shape of foil from the carrier to the stock and so that the predetermined pattern and/or shape of foil is adhesively secured to the stock, wherein the means for conveying the carrier includes first means for conveying the carrier at the speed of the stock at least during each printing operation, and second means for moving the carrier at a lower speed between printing operations, wherein the first means includes periodically-operating means for displacing the carrier downstream of the printing position.

53. Apparatus as claimed in claim 52, wherein the displacing means includes means for deflecting the carrier substantially in a transverse direction.

54. Apparatus as claimed in claim 52, wherein the displacing means is arranged to modulate the speed of the carrier so that it matches the speed of the stock during the printing operation.

55. Apparatus as claimed in claim 52, wherein the displacing means includes a roller movable to extend the path of the carrier by means synchronized with the printing means.

56. Apparatus as claimed in claim 52, wherein the second means includes drive means for the carrier downstream of said first means, said drive means being arranged to move the carrier at a speed corresponding to advancement of the carrier by one pitch of said predetermined pattern and/or shape for each printing operation.

57. Apparatus as claimed in claim 56, wherein the drive means is arranged to move the carrier at a nominal speed corresponding to its average speed during and between each printing operation.

58. Apparatus for applying foil to a stock, comprising:
means for conveying a carrier for the foil towards a printing position;
means for conveying a stock towards the printing position; and
printing means at which the carrier and stock are moved together past said printing position at which pressure is applied to transfer a predetermined pattern and/or shape of foil from the carrier to the stock and so that the predetermined pattern and/or shape of foil is adhesively secured to the stock, wherein the means for conveying the carrier includes first means for conveying the carrier at the speed of the stock at least during each printing operation, and second means for moving the carrier at a lower speed between printing operations, the second means including drive means arranged downstream of said printing position for conveying the carrier at a nominal speed substantially corresponding to the average of the speed of the carrier during and between said printing operations.

59. Apparatus as claimed in claim 58, wherein the drive means is arranged to move the carrier at a speed controlled in response to timing signals to maintain synchronization of the carrier and stock.

60. Apparatus as claimed in claim 59, wherein the drive means includes a drive roll having a compliant portion whereby its peripheral speed may be adjusted independently of its rotational speed.

61. Apparatus as claimed in claim 60, wherein the drive roll has a resilient peripheral surface.

62. Apparatus as claimed in claim 60, including a counter roll and means for applying an adjustable or variable load between said drive roll and said counter roll.

63. Apparatus as claimed in claim 62, wherein the load applying means includes means providing first and second loads corresponding respectively to a first speed slightly lower than and a second speed slightly higher than a peripheral speed corresponding to said nominal speed.

64. Apparatus as claimed in claim 63, including means for switching between said first and second loads in response to signals dependent on synchronization of the carrier and the stock.

65. Apparatus as claimed in claim 62, wherein the load applying means includes electromagnetic means.

66. Apparatus as claimed claim 58, wherein said second means includes pneumatic means upstream of said printing position.

67. A method of applying foil to a stock, including:
conveying a carrier for the foil towards a printing position; and
conveying a stock towards the printing position, moving the carrier and stock together past said printing position so as to transfer successive predetermined patterns and/or shapes of foil from the carrier to the stock and so that the predetermined pattern and/or shape of foil is adhesively secured to the stock, conveying the carrier at a desired speed at least during each printing operation and at a lower speed between printing operations, conveying the carrier at a position downstream of the printing position at a nominal speed which corresponds to the average speed of the carrier during and between printing operations, and modulating the speed of the carrier between the printing position and said downstream position so as to achieve the desired speed of the carrier during each printing operation.

68. A method as claimed in claim 67, wherein said desired speed corresponds to the speed of the stock.

69. Apparatus for applying foil to a stock comprising:
means for conveying a carrier for the foil together with an adhesive which is activated by heat towards a printing position;
means for conveying a stock towards said printing position; and
printing means at which the carrier and stock are moved together past said printing position at which pressure is applied to transfer a predetermined pattern and/or shape of foil from the carrier to the stock, including means for applying heat to activate the adhesive at or upstream of the printing position, and cooling means downstream of said printing position for assisting setting of said adhesive, whereby the foil is adhesively secured to the stock and the carrier may be separated from the foil adjacent said printing position.

70. Apparatus as claimed in claim 69, wherein the cooling means comprises means for directing cooling air at the printing position or at the carrier just downstream of the printing position.

71. Apparatus as claimed in claim 70, including a print wheel and a counter wheel at said printing position, said means for directing cooling air being arranged to direct said cooling air at the counter wheel just downstream of the printing position.

72. Apparatus as claimed in claim 69, further including means downstream of the printing position for separating the carrier and the stock.

73. Apparatus as claimed in claim 72, wherein the separating means comprises stripper means.

74. Apparatus for applying foil to a stock, comprising:
means for conveying a carrier for the foil towards a printing position, the foil carrying on an outer side an adhesive which is activated by heat;
means for conveying a stock towards said printing position; and
printing means at which the carrier and stock are moved together past said printing position at which pressure is applied to transfer a predetermined pattern and/or shape of foil from the carrier to the stock and so that adhesive secures the predetermined pattern and/or shape of foil to the stock, and preheating means for transferring heat to the carrier before it reaches the printing position and/or before it contacts the stock, wherein the preheating means comprises means extending longitudinally of the path for the carrier substantially up to the printing position.

75. Apparatus as claimed in claim 74, wherein the preheating means comprises heated guide means.

76. Apparatus as claimed in claim 75, wherein the guide means includes means defining a channel for the carrier and means is provided for supplying heated air to the channel.

77. Apparatus as claimed in claim 75, wherein the guide means is formed with a slight curvature to maintain the carrier in contact with a surface of the guide means.

78. Apparatus as claimed in claim 74, wherein the preheating means comprises means carried by the printing means.

79. Apparatus as claimed in claim 78, wherein the printing means comprises rotary means and the preheating means comprises means for guiding the carrier into contact with the printing means upstream of the printing position, whereby heat may be transferred to the carrier while it is being conveyed to said position.

80. Apparatus as claimed in claim 78, wherein the printing means comprises spaced first regions for transferring the predetermined pattern and/or shape of foil at said printing position and second regions intermediate said first regions.

81. Apparatus as claimed in claim 80, wherein said second regions are heated.

82. Apparatus as claimed in claim 81, wherein said first and second regions are separately heated, so that said second regions are generally at a lower temperature than said first regions.
